(19) United States
(12) Patent Application Publication
(10) Pub. No.: US 2023/0205853 A1
(43) Pub. Date: Jun. 29, 2023

(54) COPYRIGHT PROTECTION ASSISTANCE SYSTEM

(71) Applicant: Hideki Mizukami, Tokyo (JP)

(72) Inventor: Hideki Mizukami, Tokyo (JP)

(21) Appl. No.: 17/925,991

(22) PCT Filed: Apr. 28, 2021
(86) PCT No.: PCT/JP2021/017120

§ 371 Date: Nov. 17, 2022

(30) Foreign Application Priority Data
May 20, 2020 (JP) 2020-088464

(51) Int. Cl. G06F 21/16; G06T 1/00; H04N 1/32

(52) U.S. Cl. CPC G06F 21/16; G06T 1/0021; H04N 1/32288; G06F 2221/0733

(57) ABSTRACT

In a copyright protection assistance system 1, a content delivery device 2 stores embedded region specification information having identification information and a page of comic contents, and definition information of an embedded region in the page, and user information of a logged-in user receiving delivery of the comic contents, embeds, in response to a request for delivery of specific comic contents by a specific user, the user information of the specific user by means of a difficult-to-perceive digital watermark in the embedded region specified by the embedded region specification information corresponding to the identification information of the specific comic contents, delivers the specific comic contents to the specific user, and transmits the identification information of the delivered specific comic contents and the user information of the specific user in association with each other to a copyright management device 3 for storage purpose.

### TECHNICAL FIELD

The present invention relates to a copyright protection assistance system configured to assist copyright protection by embedding a digital watermark in image contents.

### BACKGROUND ART

There is known a technique for protecting copyright by embedding a digital watermark in image contents for delivery at the time of circulating the image contents. As such a digitally-watermarking technique, Patent Document 1 discloses the technique of embedding a digital watermark by slightly changing a pixel value of image contents for the purpose of copyright protection of the image contents to be circulated, and adding a pattern similar to the digital watermark in a peripheral region of the embedded region in which the digital watermark is embedded in the image contents, so as to make the digital watermark less noticeable.

Patent Document 2 discloses, as the method for embedding digitally-watermarked information in a high-resolution image without the reduction of the embedded digitally-watermarked information even in the case where the high-resolution image is converted into a low-resolution image, the method of generating a conversion image by converting a targeted high-resolution image into a low-resolution image, embedding a digital watermark in the conversion image, generating a difference image indicating a low-resolution embedded pixel from the embedded image with the digital watermark embedded and the original conversion image, generating an enlarged difference image including an enlarged embedded pixel by enlarging the difference image based on the resolution of the targeted image, embedding an enlarged difference pixel in the targeted high-resolution image, to generate a high-resolution embedded image.

### CITATION LIST

### Patent Literature

[Patent Document 1] Japanese Patent Application Laid-Open Publication No. 2018-182509

[Patent Document 2] Japanese Patent Application Laid-Open Publication No. 2018-198397

### SUMMARY OF INVENTION

### Technical Problem

There have been many websites illegally disclosing pirate copies of comic contents on the Internet without obtaining consent of copyright holders, recently. The operators of the websites disclosing pirate copies and the persons having uploaded comic contents to the websites disclosing pirate copies unreasonably earn huge profits. Comic contents are often uploaded and disclosed on the websites disclosing pirate copies, even immediately after the publication of comic contents, and copyright holders suffer severe damage. Although such websites disclosing pirate copies and illegal uploaders are regulated, many of such websites disclosing pirate copies are operated by servers outside the country, and it is not easy to expose those websites. There is a need for a technical system capable of assisting the regulation against such websites disclosing pirate copies and illegal uploaders.

To deal with the above issues, the present invention provides a copyright protection assistance system capable of facilitating copyright protection of a copyright holder of comic contents, by promptly specifying an illegal uploader having uploaded comic contents to a website disclosing pirate copies, and assisting regulation against various types of websites disclosing pirate copies and uploaders due to its excellency in applicability and versatility to various types of comic contents.

### Solution to Problem

In the copyright protection assistance system according to the present invention, a content delivery device stores embedded region specification information having identification information of comic contents, a page of the comic contents, and definition information of an embedded region in the page, and user information of a logged-in user receiving delivery of the comic contents; in response to a request for delivery of specific comic contents by a specific user, embeds the user information of the specific user by means of a difficult-to-perceive digital watermark in the embedded region specified by the embedded region specification information corresponding to the identification information of the specific comic contents, and delivers the specific comic contents with the user information of the specific user embedded by means of the digital watermark, to a user terminal of the specific user; and transmits the identification information of the delivered specific comic contents and the user information of the specific user in association with each other to a copyright management device for storage purpose.

The embedding of the user information of the specific user having made the request for delivery by means of the digital watermark in the embedded region specified by the embedded region specification information of the comic contents, in response to the request for delivery of the comic contents by the user, the delivery of the comic contents to the user, and the transmission of the identification information of the delivered comic contents and the user information of the user in association with each other to the copyright management device for storage purpose, by the content delivery device, enable to promptly specify, in the case where the delivered comic contents have been illegally uploaded to a website disclosing pirate copies, the uploader having illegally uploaded the comic contents to the website disclosing pirate copies, by downloading the comic contents disclosed on the website disclosing pirate copies and checking the digitally-watermarked user information. Moreover, the embedding of the specific user information to the comic contents to be delivered by means of the difficult-to-perceive digital watermark, and the transmission of the identification information of the delivered comic contents and the corresponding user information to the copyright management device for storage purpose surely enable a user to smoothly read the comic contents, allow application to any type of comic contents, and provide excellency in applicability and versatility to various types of comic contents. Accordingly, the copyright protection assistance system is capable of facilitating the copyright protection of copyright holders of comic contents, by assisting the regulation against various types of websites disclosing pirate copies and uploaders.

In the copyright protection assistance system according to the present invention, the content delivery device embeds, by means of the digital watermark in the embedded region of the specific comic contents, the user information of the specific user so as to be detectable in a resolution conversion image converted to have a resolution lower than a resolution of the specific comic contents.

Therefore, the copyright protection assistance system is capable of promptly specifying the uploader having illegally uploaded the comic contents to the website disclosing pirate copies, coping with low-resolution processing of the comic contents even in the case where the delivered comic contents have been uploaded at a low resolution to the website disclosing pirate copies and disclosed, the case where the comic contents uploaded on the website disclosing pirate copies have been converted to have a low resolution and disclosed or other case, by downloading the comic contents disclosed on the website disclosing pirate copies and checking the digitally-watermarked specific user information.

In the copyright protection assistance system according to the present invention, the content delivery device embeds, by means of the digital watermark, the user information of the identical specific user in a plurality of the embedded regions in different pages specified by the embedded region specification information corresponding to the identification information of the specific comic contents.

The embedding enables to promptly specify the uploader having illegally uploaded comic contents to the website disclosing pirate copies, coping with even the case where delivered comic contents have been partially uploaded to the website disclosing pirate copies and disclosed, by downloading some of the comic contents disclosed on the website disclosing pirate copies and checking the digitally-watermarked specific user information.

In the copyright protection assistance system according to the present invention, the content delivery device embeds, by means of the digital watermark, first user information of the specific user so as to be detectable in a low-resolution conversion image converted to have a resolution lower than the resolution of the specific comic contents, in a first embedded region specified by the embedded region specification information corresponding to the identification information of the specific comic contents, and embeds, by means of the digital watermark, second user information including the first user information and additionally including history information of delivery of the specific comic contents as the user information of the identical specific user, so as to be detectable in a conversion image converted to have a resolution higher than the low-resolution conversion image and lower than the resolution of the specific comic contents, in a second embedded region different from the first embedded region in the identical page to or a different page from the first embedded region specified by the embedded region specification information corresponding to the identification information of the specific comic contents.

The embedding enables to promptly specify the uploader having illegally uploaded comic contents to the website disclosing pirate copies, coping with the low-resolution processing of the comic contents even in the case where the delivered comic contents having been uploaded to the website disclosing pirate copies and disclosed at a lower resolution, the case where the comic contents uploaded on the website disclosing pirate copies having been converted to have a lower resolution and disclosed, or other case, by downloading the comic contents disclosed on the website disclosing pirate copies and checking the digitally-watermarked first user information of the specific user. In addition, the embedding by means of the digital watermark of the second user information of the identical specific user additionally including the history information of delivery of the specific comic contents, separately from the first user information, so as to be detectable in the conversion image converted to have a resolution higher than the low-resolution conversion image and lower than the resolution of the specific comic contents, leads to the embedding of the detailed history information of delivery of the illegally-uploaded comic contents, such as the purchase website through which the illegally-uploaded comic contents have been delivered, and delivery date and time, and thus enables to more promptly and accurately specify the uploader having illegally uploaded the comic contents to the website disclosing pirate copies, and more easily prove the fact of the illegal uploading.

In the copyright protection assistance system according to the present invention, the definition information of the embedded region of the embedded region specification information is defined based on a lateral base vector connecting corner end points in a lateral direction of a frame range in the page in the embedded region specification information and a vertical base vector connecting corner end points in a vertical direction of the frame range in the page.

The definition above leads to the definition and specification of the embedded region subjected to digital watermarking in the comic contents regardless of the difference in size of margins outside basic frames in the comic contents or margins outside frame ranges, and thus enables to comprehensively specify the embedded regions subjected to digital watermarking in various types of comic contents by the same processing, and set the digital watermark.

In the copyright protection assistance system according to the present invention, the content delivery device receives, from the copyright management device, and stores the embedded region specification information uniformly set for the specific comic contents, having the identification information of the comic contents, the page of the comic contents, and the definition information of the embedded region in the page.

The copyright management device is allowed to uniformly set the embedded region specification information for specifying the embedded regions in the respective comic contents and manage the embedded regions for each of the comic contents. The copyright management device is thus able to easily carry out the management, by unitarily managing the embedded region specification information and the embedded regions for the comic contents, even in the case where a large number of the content delivery devices 2 are installed. The management of the embedded region specification information and the embedded regions for the comic contents by the copyright management device carrying out the copyright management facilitates obtaining of consent of copyright holders with respect to the embedding of user information by means of the digital watermark in the comic contents. Moreover, the setting of the same embedded region in the respective comic contents limits the position subjected to the checking of the digitally-watermarked user information at the time of downloading the comic contents disclosed on the website disclosing pirate copies and checking the digitally-watermarked user information, and accordingly enables to detect the digitally-watermarked user information by more prompt processing.

In the copyright protection assistance system according to the present invention, a content delivery device is configured to store embedded region specification information having identification information of comic contents, a page of the comic contents, and definition information of an embedded region in the page, and user information of a logged-in user receiving delivery of the comic contents, embed, in response to a request for delivery of specific comic contents by a specific user, the user information of the specific user by means of a difficult-to-perceive digital watermark in the embedded region specified by the embedded region specification information corresponding to the identification information of the specific comic contents, and deliver the specific comic contents with the user information of the specific user embedded by means of the digital watermark, to a user terminal of the specific user, and a copyright management device transmits, to the content delivery device, embedded region specification information uniformly set for specific comic contents, having identification information of comic contents, a page of the comic contents, and definition information of an embedded region in the page, receives, from the content delivery device, and stores the identification information of the delivered specific comic contents and the corresponding user information of the specific user receiving delivery, downloads, from a fraudulent server, fraudulent comic contents with contents at least partially identical to the specific comic contents having been illegally uploaded and disclosed, detects the user information embedded by means of the digital watermark of the fraudulent comic contents in a region corresponding to the embedded region of the embedded region specification information of the specific comic contents, and specifies the detected user information embedded by means of the digital watermark by collating the detected user information with the stored user information corresponding to the identification information of the specific comic contents.

The copyright management device is allowed to uniformly set the embedded region specification information for specifying the embedded regions in the respective comic contents and manage the embedded regions for each of the comic contents. The copyright management device is thus able to easily carry out the management by unitarily managing the embedded region specification information and the embedded regions for the comic contents. The management of the embedded region specification information and the embedded regions for the comic contents by the copyright management device carrying out the copyright management facilitates obtaining of consent of copyright with respect to the embedding of user information by means of the digital watermark in the comic contents. Moreover, the setting of the same embedded region in the respective comic contents limits the position subjected to the checking of the digitally-watermarked user information at the time of downloading the comic contents disclosed on the website disclosing pirate copies and checking the digitally-watermarked user information, and accordingly enables to detect the digitally-watermarked user information by more prompt processing. In response to the request for delivery of comic contents made by a user, the embedding of the user information of the specific user having made the request for delivery, by means of the digital watermark in the embedded region specified by the embedded region specification information of the comic contents, the delivery of the comic contents to the user, and the transmission of the identification information of the delivered comic contents and the user information of the user in association with each other to the copyright management device for storage purpose, by the content delivery device, enables the copyright management device to promptly specify, in the case where the delivered comic contents have been illegally uploaded to the website disclosing pirate copies, the uploader having illegally uploaded the comic contents to the website disclosing pirate copies, by downloading the comic contents disclosed on the website disclosing pirate copies and checking the digitally-watermarked user information. The embedding of the specific user information by means of the difficult-to-perceive digital watermark in the comic contents to be delivered, and the transmission of the identification information of the delivered comic contents and the corresponding user information to the copyright management device for storage purpose surely enable a user to smoothly read the comic contents, further allow application to any type of comic contents, and provide excellency in applicability and versatility to various types of comic contents. Accordingly, the copyright protection assistance system is capable of facilitating the copyright protection of copyright holders of comic contents, by assisting the regulation against various types of illegal websites disclosing pirate copies and illegal uploaders.

### Advantageous Effects of Invention

The copyright protection assistance system according to the present invention is capable of facilitating copyright protection of copyright holders of comic contents, by promptly specifying illegal uploaders having uploaded comic contents to websites disclosing pirate copies, and assisting regulation against various types of websites disclosing pirate copies and illegal uploaders due to its excellency in applicability and versatility to various types of comic contents.

### BRIEF DESCRIPTION OF DRAWINGS

FIG. 1 is a block diagram illustrating an entire configuration of a copyright protection assistance system of the embodiment according to the present invention.

FIG. 2 is a block diagram illustrating a configuration of a content delivery device in the copyright protection assistance system of the embodiment.

FIG. 3 illustrates an example of embedded region specification information to be stored in the copyright protection assistance system of the embodiment.

FIG. 4 is a block diagram illustrating a configuration of a copyright management device in the copyright protection assistance system of the embodiment.

FIG. 5 is a flowchart illustrating content delivery processing in the copyright protection assistance system of the embodiment.

FIG. 6 is a flowchart illustrating fraudulence detection processing in the copyright protection assistance system of the embodiment.

### DESCRIPTION OF EMBODIMENTS

Copyright protection assistance system of the embodiment

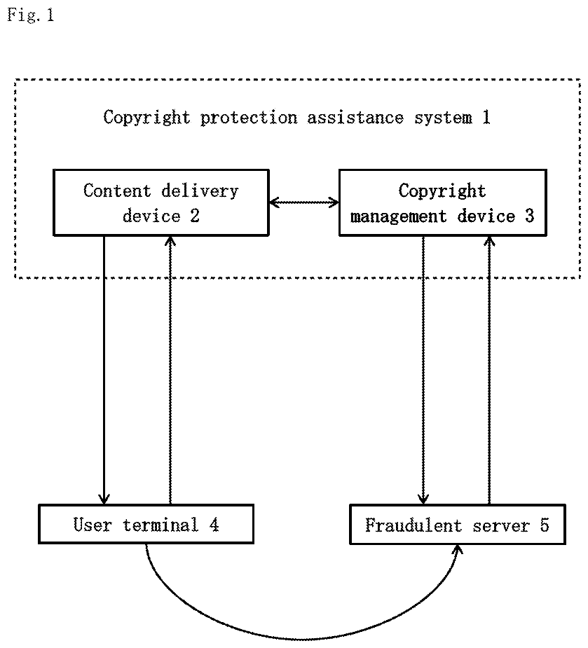

As shown in FIG. 1, a copyright protection assistance system 1 of the embodiment according to the present invention includes a content delivery device 2 and a copyright management device 3. The content delivery device 2 and the copyright management device 3 are connected to each other via a communication line, and configured to function as the copyright protection assistance system 1 as a whole while cooperating with each other by transmitting and receiving data to and from each other.

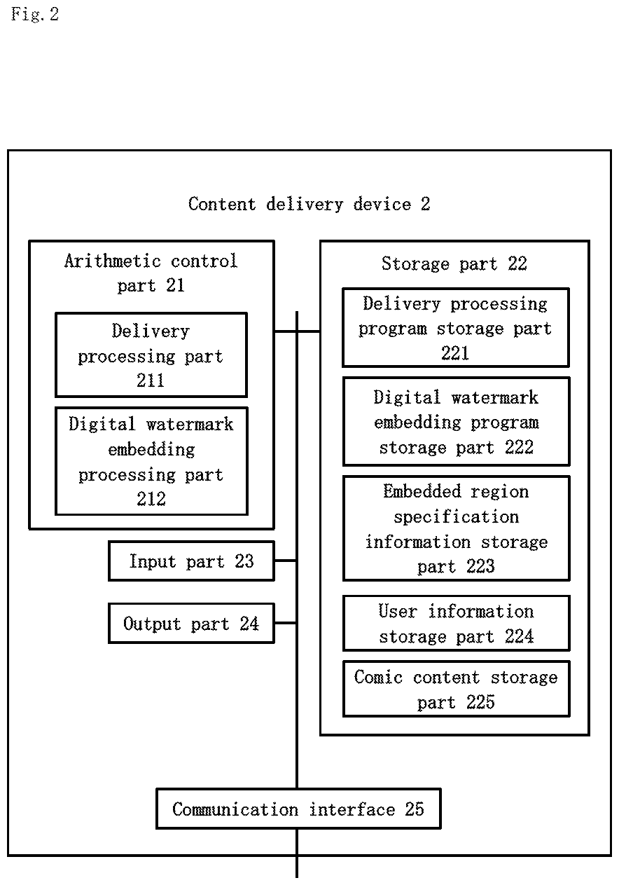

The content delivery device 2 is configured with, for example, a single server or a server group in which servers are communicatively connected via a communication line so as to cooperate with each other. As shown in FIG. 2, the content delivery device 2 includes an arithmetic control part 21 such as an MPU or a CPU, a storage part 22 configured with a ROM, a RAM, a flash memory, an HDD, an SSD and the like, an input part 23 such as a mouse and a keyboard, an output part 24 such as a display and a printer, and a communication interface 25 for transmitting and receiving data via a communication line.

The storage part 22 stores a delivery processing program for making the arithmetic control part 21 execute delivery processing of delivering comic contents, in a delivery processing program storage part 221. A delivery processing part 211 of the arithmetic control part 21 is configured to execute the delivery processing of delivering predetermined comic contents while cooperating with the stored delivery processing program. The storage part 22 stores a digital watermark embedding program for making the arithmetic control part 21 execute digital watermark embedding processing, in a digital watermark embedding program storage part 222. A digital watermark embedding processing part 212 of the arithmetic control part 21 is configured to execute the predetermined digital watermark embedding processing while cooperating with the stored digital watermark embedding program. The digital watermark embedding processing part 212 embeds user information of a specific user in the embedded region specified by the embedded region specification information corresponding to the identification information of specific comic contents, by means of a difficult-to-perceive digital watermark, in response to the request for delivery of the specific comic contents by the specific user. The delivery processing part 211 delivers, to the specific user, the specific comic contents in which the user information of the specific user is embedded by means of the digital watermark, and further transmits, for storage purpose, the identification information of the delivered specific comic contents and the user information of the specific user in association with each other, to the copyright management device 3.

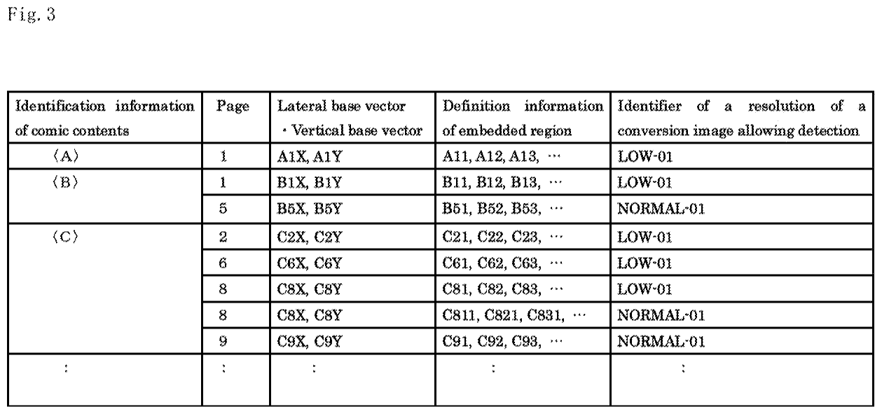

The storage part 22 has an embedded region specification information storage part 223 which stores embedded region specification information. The embedded region specification information has identification information of comic contents for identifying comic contents with identical contents, a page in the comic contents identified by the identification information of the comic contents, and definition information of embedded region for defining a digital watermark embedded region in the page. As shown in FIG. 3, the embedded region specification information has the configuration including, for example, an identification information <A> of comic contents for identifying comic contents with identical contents, a page 1 in the comic contents identified by the identification information <A> of comic contents, a lateral base vector A1X connecting the corner end points in the lateral direction of the frame range in the page 1 corresponding to the definition information of embedded region and a vertical base vector A1Y connecting the corner end points in the vertical direction of the frame range in the page 1, definition information A11, A12, A13, etc. of embedded region, and an identifier LOW-01 of a resolution of a conversion image allowing detection.

The definition information of embedded region is defined based on the lateral base vector connecting the corner end points in the lateral direction of the frame range in the page corresponding to the definition information of embedded region, and the vertical base vector connecting the corner end points in the vertical direction of the frame range in the page. In an example, the definition information is defined as A11, A12, A13, etc. of the vector group indicating the outer peripheral edges of the embedded region and of the vector group indicating the inside region of the edges in the coordinate system with the lateral base vector A1X and the vertical base vector A1Y of the identification information <A> of comic contents. Each of A11, A12, A13, etc. of the vector group is obtained by linearly combining the lateral base vector A1X and the vertical base vector A1Y. The definition information of embedded region may be configured only with the vector group subjected to the linear combination indicating the outer peripheral edges of the embedded region in the coordinate system with the lateral base vector A1X and the vertical base vector A1Y of the identification information <A> of comic contents, or may be configured with the representative vector group subjected to the linear combination indicating three or more representative points in the coordinate system with the lateral base vector A1X and the vertical base vector A1Y of the identification information <A> of comic contents and the line segments connecting the top end coordinate values of the representative vector group.

The embedded region specification information corresponding to each of the identification information of comic contents to be stored in the embedded region specification information storage part 223 may include a plurality of embedded regions, in accordance with conditions such as the presence of the region allowing embedding in the comic contents or the consent of copyright holders of the comic contents, or as necessary. In an example, the identification information <A> of comic contents in FIG. 3 has one embedded region; an identification information <B> of comic contents has two embedded regions; and an identification information <C> of comic contents has four embedded regions.

In the example of FIG. 3, the embedded region specification information of the identification information <B> of comic contents has the configuration including a page 1 in the comic contents identified by the identification information <B> of comic contents, a lateral base vector B1X connecting the corner end points in the lateral direction of the frame range in the page 1 and a vertical base vector B1Y connecting the corner end points in the vertical direction of the frame range in the page 1, definition information B11, B12, B13, etc. of embedded region which are respectively defined by linear combination of the lateral base vector B1X and the vertical base vector B1Y, and the identifier LOW-01 of the resolution of the conversion image allowing detection, and the configuration including a page 5 in the comic contents identified by the identification information <B> of comic contents, a lateral base vector B5X connecting the corner end points in the lateral direction of the frame range in the page 5 and a vertical base vector B5Y connecting the corner end points in the vertical direction of the frame range in the page 5, definition information B51, B52, B53, etc. of embedded region which are respectively defined by linear combination of the lateral base vector B5X and the vertical base vector B5Y, and an identifier NORMAL-01 of the resolution of the conversion image allowing detection.

Herein, the identifier LOW-01 of the resolution of the conversion image allowing detection indicates that detection is allowed even in the case of the image having been converted to have a predetermined resolution lower than the resolution of the comic contents to be delivered, and is set as the identifier indicating, for example, the resolution at which detection is allowed even in the case where the comic contents of the identification information <B> to be delivered with a resolution of 300 DPI are converted to have a lower resolution of 72 DPI. A plurality of resolutions for identifiers of resolutions lower than the resolution of the comic contents to be delivered may be set stepwise in accordance with the amount of information to be embedded. In this case, the identifiers are set as, for example, LOW-01, LOW-02, LOW-03 and the like in descending order of the resolutions. The identifier NORMAL-01 of the resolution of the conversion image allowing detection indicates that detection is allowed at the same resolution as the resolution of the comic contents to be delivered.

In the example of FIG. 3, the embedded region specification information of the identification information <C> of comic contents has the configuration including a page 2 in the comic contents identified by the identification information <C> of comic contents, a lateral base vector C2X connecting the corner end points in the lateral direction of the frame range in the page 2 and a vertical base vector C2Y connecting the corner end points in the vertical direction of the frame range in the page 1, definition information C21, C22, C23, etc. of embedded region which are respectively defined by linear combination of the lateral base vector C2X and the vertical base vector C2Y, and the identifier LOW-01 of the resolution of the conversion image allowing detection, the configuration including a page 6 in the comic contents identified by the identification information <C> of comic contents, a lateral base vector C6X connecting the corner end points in the lateral direction of the frame range in the page 6 and a vertical base vector C6Y connecting the corner end points in the vertical direction of the frame range in the page 6, definition information C61, C62, C63, etc. of embedded region which are respectively defined by linear combination of the lateral base vector C6X and the vertical base vector C6Y, and the identifier LOW-01 of the resolution of the conversion image allowing detection, and the configuration including a page 8 in the comic contents identified by the identification information <C> of comic contents, a lateral base vector C8X connecting the corner end points in the lateral direction of the frame range in the page 8 and a vertical base vector C8Y connecting the corner end points in the vertical direction of the frame range in the page 8, definition information C81, C82, C83, etc. of embedded region which are respectively defined by linear combination of the lateral base vector C8X and the vertical base vector C8Y, and the identifier LOW-01 of the resolution of the conversion image allowing detection.

In the example of FIG. 3, the embedded region specification information of the identification information <C> of comic contents further has the configuration including the page 8 identical to the above-described page 8 in the comic contents identified by the identification information <C> of comic contents, the lateral base vector C8X connecting the corner end points in the lateral direction of the frame range in the page 8 and the vertical base vector C8Y connecting the corner end points in the vertical direction of the frame range in the page 8, definition information C811, C821, C831, etc. of embedded region which are respectively defined by linear combination of the lateral base vector C8X and the vertical base vector C8Y, and the identifier NORMAL-01 of the resolution of the conversion image allowing detection, and the configuration including a page 9 in the comic contents identified by the identification information <C> of comic contents, a lateral base vector C9X connecting the corner end points in the lateral direction of the frame range in the page 9 and a vertical base vector C9Y connecting the corner end points in the vertical direction of the frame range in the page 9, definition information C91, C92, C93, etc. of embedded region which are respectively defined by linear combination of the lateral base vector C9X and the vertical base vector C9Y, and the identifier NORMAL-01 of the resolution of the conversion image allowing detection.

The storage part 22 of the content delivery device 2 has a user information storage part 224 which stores the user information. The user information storage part 224 stores information for specifying a user, for example, a user name, identification information of a user, a password corresponding to the identification information of a user, user's address and telephone number, information of a payment method with respect to a delivery region of comic contents, and the like. The storage part 22 further has a comic content storage part 225 which stores comic contents to be delivered. The comic content storage part 225 stores, for example, content data of comic contents to be delivered, resolution data of comic contents, and the like.

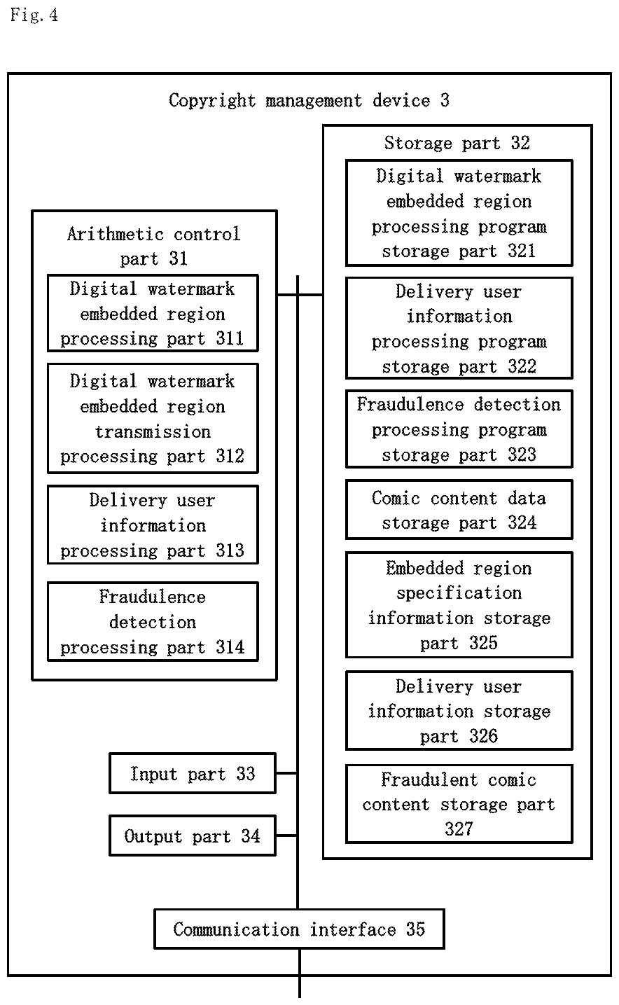

The copyright management device 3 is configured with, for example, a single server or a server group in which servers are communicatively connected via a communication line so as to cooperate with each other. As shown in FIG. 4, the copyright management device 3 includes an arithmetic control part 31 such as an MPU or a CPU, a storage part 32 configured with a ROM, a RAM, a flash memory, an HDD, an SSD and the like, an input part 33 such as a mouse and a keyboard, an output part 34 such as a display and a printer, and a communication interface 35 for transmitting and receiving data via a communication line.

The storage part 32 stores a digital watermark embedded region processing program for making the arithmetic control part 31 execute setting processing and transmitting processing of the digital watermark embedded region for the comic contents, in a digital watermark embedded region processing program storage part 321, and stores the content data, the resolution data and the like of the comic contents in which digital watermark embedded region is set, in a comic content data storage part 324. A digital watermark embedded region processing part 311 of the arithmetic control part 31 is configured to, while cooperating with the stored digital watermark embedded region processing program, execute the setting processing of setting the digital watermark embedded region for each of the comic contents stored in the comic content data storage part 324, generate and set the embedded region specification information, and store the embedded region specification information in an embedded region specification information storage part 325. A digital watermark embedded region transmission processing part 312, which cooperates with the digital watermark embedded region processing program, transmits the generated and set embedded region specification information to the content delivery device 2. The embedded region specification information is identical to the embedded region specification information stored in the embedded region specification information storage part 223 of the content delivery device 2 (refer to FIG. 3). The embedded region specification information transmitted from the copyright management device 3 to the content delivery device 2 is received by the content delivery device 2, and the content delivery device 2 stores the received embedded region specification information in the embedded region specification information storage part 223. The copyright management device 3 transmits, with respect to specific comic contents, the uniformly-set embedded region specification information including the identification information of the comic contents, the page of the comic contents, and the definition information of embedded region in the page, to the content delivery device 2.

In an example, in the setting processing of setting the digital watermark embedded region to be executed by the digital watermark embedded region processing part 311 of the copyright management device 3, in response to the specification input through the input part 33 in a predetermined region in the page 1 of the identification information <A> of comic contents, the digital watermark embedded region processing part 311 executes binarization to the page 1, extracts the upper horizontal edge nearest to the upper end side of the image in the page 1, the lower horizontal edge nearest to the lower end side thereof, the left vertical edge nearest to the left end side thereof, and the right vertical edge nearest to the right end side thereof, extracts the frame range in the page 1 by using the intersections of the extension lines of the upper and lower horizontal edges and the left and right vertical edges, sets the lateral base vector A1X connecting the corner end points in the lateral direction of the frame range in the page 1 and the vertical base vector A1Y connecting the corner end points in the vertical direction of the frame range in the page 1, defines the definition information of embedded region as A11, A12, A13, etc. of the vector group subjected to the linear combination indicating the outer peripheral edges of the embedded region and the vector group indicating the inside region of the outer peripheral edges in the coordinate system with the lateral base vector A1X and the vertical base vector A1Y, and stores the definition information of embedded region in the embedded region specification information storage part 325. In the case where a predetermined resolution lower than the comic contents of the identification information <A> is specified in response to the specification input through the input part 33 of the resolution of the conversion image allowing detection, the digital watermark embedded region processing part 311 sets the corresponding identifier LOW-01 of the resolution of the conversion image allowing detection, and stores the identifier LOW-01, in association with the identification information <A> of comic contents, the page 1 as the page number thereof, the lateral base vector A1X, the vertical base vector A1Y, and the definition information A11, A12, A13, etc. of embedded region, in the embedded region specification information storage part 325 (refer to FIG. 3). The embedded region specification information for the identification information <B>, <C>, etc. of comic content is also set and stored in the same manner. The embedded region specification information is transmitted from the copyright management device 3 to the content delivery device 2, and is stored also in the embedded region specification information storage part 223 of the content delivery device 2.

The storage part 32 stores a delivery user information processing program for making the arithmetic processing part 31 execute processing of delivery user information, in a delivery user information processing program storage part 322. A delivery user information processing part 313 of the arithmetic control part 31 is configured to execute the processing of predetermined delivery user information while cooperating with the stored delivery user information processing program. The delivery user information processing part 313 receives, from the content delivery device 2, the identification information of the delivered specific comic contents and the corresponding user information of the specific user receiving delivery, and stores the received information in a delivery user information storage part 326.

The storage part 32 stores a fraudulence detection processing program for making the arithmetic processing part 31 execute fraudulence detection processing, in a fraudulence detection processing program storage part 323. A fraudulence detection processing part 314 of the arithmetic control part 31 is configured to execute the predetermined fraudulence detection processing while cooperating with the stored fraudulence detection processing program. In response to the specification input through the input part 33 of fraudulent comic contents, the fraudulence detection processing part 314 downloads, from a fraudulent server 5, the fraudulent comic contents with contents at least partially identical to the specific comic contents which have been downloaded to a user terminal 4, and illegally uploaded to the fraudulent server 5 and disclosed, specifies the region corresponding to the embedded region of the embedded region specification information of the specific comic contents, by use of the embedded region specification information in the embedded region specification information storage part 325, detects the digitally-watermarked user information of the fraudulent comic contents in the region, specifies the detected digitally-watermarked user information by collating the detected digitally-watermarked user information with the user information corresponding to the identification information of the specific comic contents stored in the delivery user information storage part 326, and executes processing of outputting through the output part 34 and other processing (refer to FIG. 1 and FIG. 4).

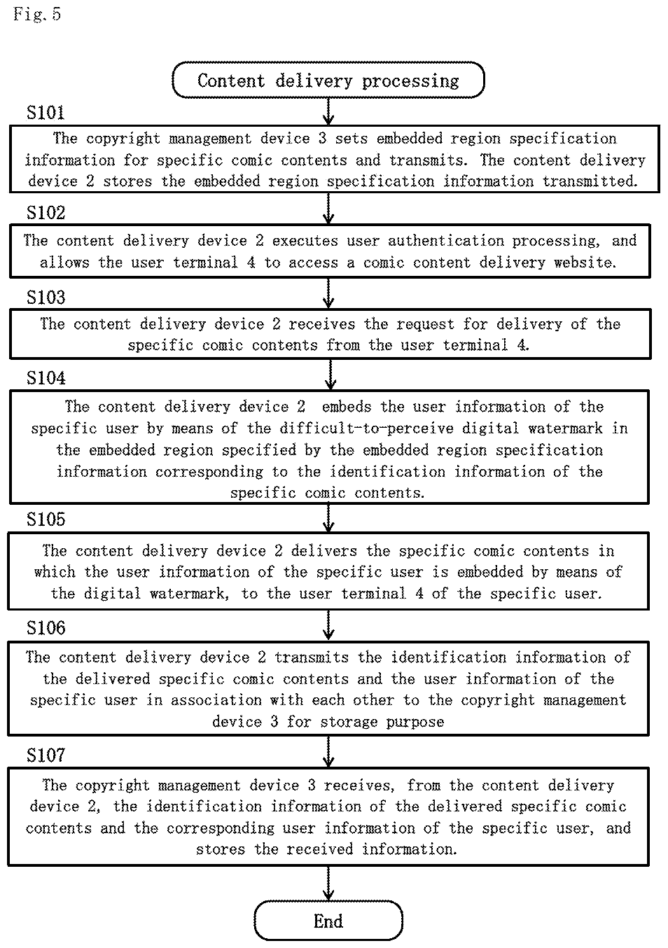

The flow in the copyright protection assistance processing to be executed by the copyright protection assistance system 1 of the present embodiment will be described below. As shown in FIG. 5, the copyright management device 3 executes the setting processing of setting embedded region specification information for specific comic contents, and transmits the set embedded region specification information to the content delivery device 2. The delivery processing part 211 of the content delivery device 2 receives the embedded region specification information transmitted from the copyright management device 3, and the embedded region specification information for the specific comic contents is stored in the embedded region specification information storage part 223 (S101).

Thereafter, the user terminal 4 of a user is connected to the content delivery device 2 via a communication line; the user inputs user's identification information (user ID) and user's password according to a login operation screen on the content delivery device 2; the content delivery device 2 executes user authentication processing by use of the user information stored in the user information storage part 224, and allows the user terminal 4 to access a comic content delivery website in response to the completion of the authentication; and the user terminal 4 logs in the comic content delivery website (S102).

The user selects the comic contents desired to be delivered on the comic content delivery website, and transmits the request for delivery of the desired comic contents through the user terminal 4, and the content delivery device 2 receives the request for delivery of the specific comic contents (S103). In response to the request for delivery of the specific comic contents, the delivery processing part 211 of the content delivery device 2 uses the embedded region specification information corresponding to the identification information of the specific comic content stored in the embedded region specification information storage part 223, and the user information which is stored in the user information storage part 224 and includes the fact of logging-in and transmission of the request for delivery of the specific comic contents, so that the user information of the specific user is embedded by means of the difficult-to-perceive digital watermark in the embedded region specified by the embedded region specification information corresponding to the identification information of the specific comic contents (S104).

For example, in the case where the comic contents subjected to the request for delivery are the comic contents of the identification information <A> in FIG. 3, the embedding of the digital watermark is executed so as to be detectable even when the comic contents are converted to the conversion image to have a resolution lower than the resolution of the comic contents of the identification information <A>, in the embedded region defined by the definition information A11, A12, A13, etc. of embedded region corresponding to the identifier LOW-01. In other words, the embedding is executed by means of the digital watermark allowing detection even in the case of the conversion image converted to have the resolution corresponding to the identifier LOW-01.

The processing of embedding the digital watermark so as to be detectable even in the case of the conversion image converted to have a lower resolution preferably includes the steps of, as in Patent Document 2 as an example, generating a conversion image by converting a targeted high-resolution image of comic contents into a low-resolution image, embedding a digital watermark in the conversion image, generating a difference image indicating a low-resolution embedded pixel from the embedded image with the digital watermark embedded and the original conversion image, generating an enlarged difference image including the enlarged embedded pixel obtained by enlarging the difference image based on the resolution of the targeted image of the comic contents, and embedding an enlarged difference pixel in the targeted image of the high-resolution comic contents. The processing may be executed by another appropriate method within an applicable range.

As another example, in the case where the comic contents subjected to the request for delivery are the comic contents of the identification information <B> in FIG. 3, the embedding of the digital watermark is executed by the same embedding processing described above, so as to be detectable even when the comic contents of the identification information <B> are converted to the conversion image to have a resolution lower than the resolution of the comic contents of the identification information <B>, in the embedded region defined by the definition information B11, B12, B13, etc. of embedded region corresponding to the identifier LOW-01. In other words, the embedding is executed by means of the digital watermark allowing detection even in the case of the conversion image converted to have the resolution corresponding to the identifier LOW-01. In addition, the embedding of the digital watermark is executed so as to be detectable at the resolution identical to the resolution of the comic contents of the identification information <B> to be delivered, in the embedded region defined by the definition information B51, B52, B53, etc. of embedded region corresponding to the identifier NORMAL-01.

In the case where the digital watermark embedding processing part 212 embeds, in a first embedded region specified by the embedded region specification information, user information (first user information) of the specific user by means of the digital watermark so as to be detectable in the low-resolution conversion image converted to have a resolution lower than the resolution of the specific comic contents, the first user information simply including basic user information such as a user name, identification information of a user, and user's address and telephone number when required is preferable because the conversion image converted from an arbitrary resolution is detectable at a further lower resolution.

On the other hand, in the case where the digital watermark embedding processing part 212 embeds, in a second embedded region different from the first embedded region in a different page from the first embedded region (or the same page) specified by the embedded region specification information, the user information of the identical specific user by means of the digital watermark so as to be detectable at the resolution identical to the resolution of the comic contents of the identification information to be delivered, the user information (second user information) preferably includes not only basic user information such as a user name, identification information of a user, and user's address and telephone number when required, but also history information of delivery of specific comic contents stored in the storage part 22, such as URL of a comic content delivery website for delivery, and delivery date and time when a comic content delivery website receives a request for delivery.

The digitally-watermarked user information including basic user information and additionally including history information of delivery of specific comic contents is not only embedded so as to be detectable at the resolution identical to the resolution of the comic contents of the identification information to be delivered, but also may be embedded so as to be detectable in the conversion image converted to have a resolution higher than the low-resolution conversion image corresponding to the identifier LOW-01 in which basic user information is simply embedded and lower than the resolution of specific comic contents.

The delivery processing part 211 of the content delivery device 2 thereafter delivers the specific comic contents in which the user information of the specific user is embedded by means of the digital watermark, to the user terminal 4 of the specific user (S105), and further transmits the identification information of the delivered specific comic contents and the user information of the specific user in association with each other to the copyright management device 3 for storage purpose (S106). The delivery user information processing part 313 of the copyright management device 3 receives, from the content delivery device 2, the identification information of the delivered specific comic contents and the corresponding user information of the specific user receiving delivery, and stores the received information in the delivery user information storage part 326 (S107). The payment of the charge for the delivered comic contents is performed by, for example, periodically drawing the charge from the withdrawal account of the user in the user information.

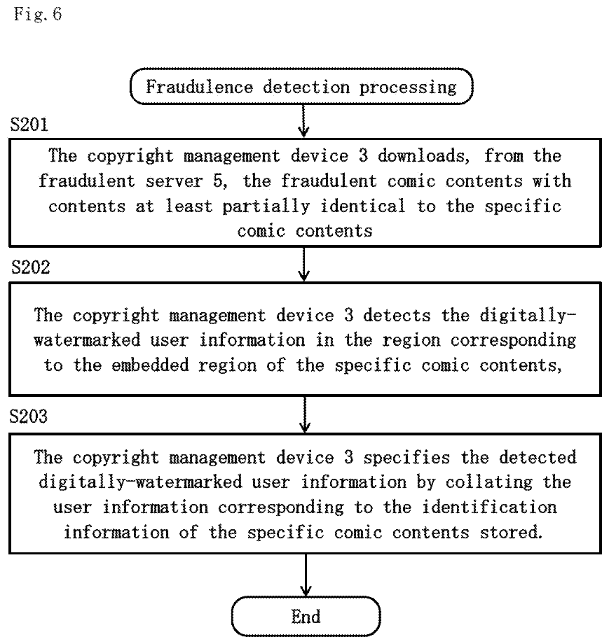

In the case where the fraudulent comic contents with contents at least partially identical to the specific comic contents which have been illegally uploaded and disclosed after the delivery of the specific comic contents are detected, as shown in FIG. 6, the fraudulence detection processing part 314 of the copyright management device 3 downloads, from the fraudulent server 5, the fraudulent comic contents with contents at least partially identical to the specific comic contents which have been illegally uploaded to the fraudulent server 5 and disclosed, in response to the input for downloading through the input part 33 (S201).

The fraudulence detection processing part 314 then specifies the region corresponding to the embedded region of the embedded region specification information of the specific comic contents, by use of the embedded region specification information in the embedded region specification information storage part 325, detects the digitally-watermarked user information of the fraudulent comic contents in the region (S202), specifies the detected digitally-watermarked user information by collating the user information corresponding to the identification information of the specific comic contents stored in the delivery user information storage part 326, and executes the processing of outputting through the output part 34 and other processing (S203).

In the copyright protection assistance system of the present embodiment, in response to the request for delivery of comic contents made by a user, the content delivery device 2 embeds the user information of the specific user having made the request for delivery, by means of the digital watermark in the embedded region specified by the embedded region specification information of the comic contents, delivers the comic contents to the user, and transmits the identification information of the delivered comic contents and the user information of the user in association with each other to the copyright management device 3 for storage purpose. This enables the copyright management device 3 to promptly specify, in the case where the delivered comic contents have been illegally uploaded to a website disclosing pirate copies, the uploader having illegally uploaded the comic contents to the website disclosing pirate copies, by downloading the comic contents disclosed on the website disclosing pirate copies and checking the digitally-watermarked user information. The embedding of the specific user information by means of the difficult-to-perceive digital watermark in the comic contents to be delivered and the transmission of the identification information of the delivered comic contents and the corresponding user information to the copyright management device 3 for storage purpose surely enable the user to smoothly read the comic contents, further allow application to any type of comic contents, and provide excellency in application and versatility to various types of comic contents. Accordingly, the copyright protection assistance system is capable of facilitating the copyright protection of copyright holders of comic contents, by assisting the regulation against various types of illegal websites disclosing pirate copies and illegal uploaders.

The content delivery device 2 embeds the user information of the specific user in the embedded region of the specific comic contents by means of the digital watermark so as to be detectable in the conversion image converted to have a resolution lower than the resolution of the specific comic contents, and the embedding enables to promptly specify the uploader having illegally uploaded the comic contents to the website disclosing pirate copies, coping with low-resolution processing of the comic contents even in the case where the delivered comic contents have been uploaded at a low resolution to the website disclosing pirate copies and disclosed, the case where the comic contents uploaded on the website disclosing pirate copies are converted to have a low resolution and disclosed, or other case, by downloading the comic contents disclosed on the website disclosing pirate copies and checking the digitally-watermarked specific user information.

In the case where the content delivery device 3 embeds the user information of identical specific user in a plurality of embedded regions in the different pages specified by the embedded region specification information corresponding to the identification information of the specific comic contents by means of the digital watermark, the embedding enables to promptly specify the uploader having illegally uploaded the comic contents to the website disclosing pirate copies, coping with even the case where the delivered comic contents have been partially uploaded to the website disclosing pirate copies and disclosed, by downloading some of the comic contents disclosed on the website disclosing pirate copies and checking the digitally-watermarked specific user information.

In the case where the content delivery device 3 embeds, by means of the digital watermark in the first embedded region specified by the embedded region specification information, the first user information which is basic user information of the specific user, so as to be detectable in the low-resolution conversion image converted to have a resolution lower than the resolution of the specific comic contents, and further embeds, by means of the digital watermark in the second embedded region different from the first embedded region, the second user information including the first user information and additionally including the history information of delivery of the specific comic contents as the user information of the identical specific user, so as to be detectable in the conversion image converted to have a resolution higher than the low-resolution conversion image and lower than the resolution of the specific comic contents, or embeds the second user information by means of the digital watermark so as to be detectable at the resolution of the specific comic contents, the embedding enables to promptly specify the uploader having illegally uploaded the comic contents to the website disclosing pirate copies, coping with the low-resolution processing of the comic contents even in the case where the delivered comic contents have been uploaded to the website disclosing pirate copies and disclosed at a lower resolution, the case where the comic contents uploaded on the website disclosing pirate copies are converted to have a lower resolution and disclosed, or other case, by downloading the comic contents disclosed on the website disclosing pirate copies and checking the digitally-watermarked first user information of the specific user. In addition, the embedding by means of the digital watermark of the second user information of the identical specific user additionally including the history information of delivery of the specific comic contents separately from the first user information enables to embed the detailed history information of delivery of the comic contents having been illegally uploaded, such as a purchase website through which the illegally uploaded comic contents are delivered, and delivery date and time, and thus enables to more promptly and accurately specify the uploader having illegally uploaded the comic contents to the website disclosing pirate copies, and more easily prove the fact of the illegal uploading.

The definition of the definition information of embedded region of the embedded region specification information based on the lateral base vector connecting the corner end points in the lateral direction of the frame range in the page specified by the embedded region specification information and the vertical base vector connecting the corner end points in the vertical direction of the frame range in the page leads to the definition and specification of the embedded region subjected to digital watermarking in the comic contents regardless of the difference in size of margins outside basic frames in the comic contents or margins outside frame divisions, and thus enables to comprehensively specify the embedded regions subjected to digital watermarking in various types of comic contents by the same processing, in setting the digital watermark.

The content delivery device 3 receives, from the copyright management device 3, and stores the embedded region specification information uniformly set for the specific comic contents, having the identification information of the comic contents, the page of the comic contents, and the definition information of embedded region in the page, and the copyright management device 3 is allowed to uniformly set the embedded region specification information for specifying the embedded regions in the respective comic contents and manage the embedded regions for each of the comic contents. The copyright management device 3 is thus able to easily carry out the management by unitarily managing the embedded region specification information and the embedded regions for the comic contents, even in the case where a large number of the content delivery devices 2 are installed. The management of the embedded region specification information and the embedded regions for the comic contents by the copyright management device 3 carrying out copyright management facilitates the obtaining of consent of copyright holders with respect to the embedding of user information by means of the digital watermark in the comic contents. Moreover, the setting of the same embedded region in the respective comic contents limits the position subjected to the checking of the digitally-watermarked user information at the time of downloading the comic contents disclosed on the website disclosing pirate copies and checking the digitally-watermarked user information, and accordingly enables to detect the digitally-watermarked user information by more prompt processing.

### Scope of the Invention Disclosed in the Present Specification

The invention disclosed in the present specification includes not only the invention described as the present invention and the embodiments, but also, in applicable range, those specified by changing some of these contents to other contents disclosed in the present specification, those specified by adding other contents disclosed in the present specification to these contents, and those specified in the form of broader concept by deleting some of these contents within the limit where some operating effect is obtained. The invention disclosed in the present specification includes also the modifications and the added contents described below.

In an example, the embedded region specification information of the comic contents includes, in the example of FIG. 3, one embedded region for the comic contents of the identification information <A>, and a plurality of embedded regions for each of the comic contents of the identification information <B> and the identification information <C>, or alternatively may include a plurality of embedded regions for each of the comic contents, or include one embedded region for each of the comic contents. In the copyright protection assistance system according to the present invention, any method of setting the digital watermark is available within the scope of the gist of the present invention.

### INDUSTRIAL APPLICABILITY

The present invention is used to assist copyright protection of comic contents to be delivered through a comic content delivery website.

### REFERENCE SIGNS LIST

1: COPYRIGHT PROTECTION ASSISTANCE SYSTEM, 2: CONTENT DELIVERY DEVICE, 21: ARITHMETIC CONTROL PART, 211: DELIVERY PROCESSING PART, 212: DIGITAL WATERMARK EMBEDDING PROCESSING PART, 22: STORAGE PART, 221: DELIVERY PROCESSING PROGRAM STORAGE PART, 222: DIGITAL WATERMARK EMBEDDING PROGRAM STORAGE PART, 223: EMBEDDED REGION SPECIFICATION INFORMATION STORAGE PART, 224: USER INFORMATION STORAGE PART, 225: COMIC CONTENT STORAGE PART, 23: INPUT PART, 24: OUTPUT PART, 25: COMMUNICATION INTERFACE, 3: COPYRIGHT MANAGEMENT DEVICE, 31: ARITHMETIC CONTROL PART, 311: DIGITAL WATERMARK EMBEDDED REGION PROCESSING PART, 312: DIGITAL WATERMARK EMBEDDED REGION TRANSMISSION PROCESSING PART, 313: DELIVERY USER INFORMATION PROCESSING PART, 314: FRAUDULENCE DETECTION PROCESSING PART, 32: STORAGE PART, 321: DIGITAL WATERMARK EMBEDDED REGION PROCESSING PROGRAM STORAGE PART, 322: DELIVERY USER INFORMATION PROCESSING PROGRAM STORAGE PART, 323: FRAUDULENCE DETECTION PROCESSING PROGRAM STORAGE PART, 324: COMIC CONTENT DATA STORAGE PART, 325: EMBEDDED REGION SPECIFICATION INFORMATION STORAGE PART, 326: DELIVERY USER INFORMATION STORAGE PART, 327: FRAUDULENT COMIC CONTENT STORAGE PART, 33: INPUT PART, 34: OUTPUT PART, 35: COMMUNICATION INTERFACE, 4: USER TERMINAL, 5: FRAUDULENT SERVER

1-7. (canceled)

8. A copyright protection assistance system, wherein
a content delivery device
stores embedded region specification information having identification information of comic contents, a page of the comic contents, and definition information of an embedded region in the page, and user information of a logged-in user receiving delivery of the comic contents,
in response to a request for delivery of specific comic contents by a specific user, embeds the user information of the specific user by means of a difficult-to-perceive digital watermark in the embedded region specified by the embedded region specification information corresponding to the identification information of the specific comic contents, and delivers the specific comic contents with the user information of the specific user embedded by means of the digital watermark, to a user terminal of the specific user, and
transmits the identification information of the delivered specific comic contents and the user information of the specific user in association with each other to a copyright management device for storage purpose.

9. The copyright protection assistance system according to claim 8, wherein
the content delivery device embeds, by means of the digital watermark, the user information of the specific user so as to be detectable in a resolution conversion image converted to have a resolution lower than a resolution of the specific comic contents, in the embedded region of the specific comic contents.

10. The copyright protection assistance system according to claim 8, wherein
the content delivery device embeds, by means of the digital watermark, the user information of the identical specific user in a plurality of the embedded regions in different pages specified by the embedded region specification information corresponding to the identification information of the specific comic contents.

11. The copyright protection assistance system according to claim 9, wherein
the content delivery device embeds, by means of the digital watermark, the user information of the identical specific user in a plurality of the embedded regions in different pages specified by the embedded region specification information corresponding to the identification information of the specific comic contents.

12. The copyright protection assistance system according to claim 8, wherein
the content delivery device
embeds, by means of the digital watermark, first user information of the specific user so as to be detectable in a low-resolution conversion image converted to have a resolution lower than the resolution of the specific comic contents, in a first embedded region specified by the embedded region specification information corresponding to the identification information of the specific comic contents, and
embeds, by means of the digital watermark, second user information including the first user information and additionally including history information of delivery of the specific comic contents as the user information of the identical specific user, so as to be detectable in a conversion image converted to have a resolution higher than the low-resolution conversion image and lower than the resolution of the specific comic contents, in a second embedded region different from the first embedded region in the identical page to or a different page from the first embedded region specified by the embedded region specification information corresponding to the identification information of the specific comic contents.

13. The copyright protection assistance system according to claim 9, wherein
the content delivery device
embeds, by means of the digital watermark, first user information of the specific user so as to be detectable in a low-resolution conversion image converted to have a resolution lower than the resolution of the specific comic contents, in a first embedded region specified by the embedded region specification information corresponding to the identification information of the specific comic contents, and
embeds, by means of the digital watermark, second user information including the first user information and additionally including history information of delivery of the specific comic contents as the user information of the identical specific user, so as to be detectable in a conversion image converted to have a resolution higher than the low-resolution conversion image and lower than the resolution of the specific comic contents, in a second embedded region different from the first embedded region in the identical page to or a different page from the first embedded region specified by the embedded region specification information corresponding to the identification information of the specific comic contents.

14. The copyright protection assistance system according to claim 10, wherein
the content delivery device
embeds, by means of the digital watermark, first user information of the specific user so as to be detectable in a low-resolution conversion image converted to have a resolution lower than the resolution of the specific comic contents, in a first embedded region specified by the embedded region specification information corresponding to the identification information of the specific comic contents, and
embeds, by means of the digital watermark, second user information including the first user information and additionally including history information of delivery of the specific comic contents as the user information of the identical specific user, so as to be detectable in a conversion image converted to have a resolution higher than the low-resolution conversion image and lower than the resolution of the specific comic contents, in a second embedded region different from the first embedded region in the identical page to or a different page from the first embedded region specified by the embedded region specification information corresponding to the identification information of the specific comic contents.

15. The copyright protection assistance system according to claim 11, wherein
the content delivery device
embeds, by means of the digital watermark, first user information of the specific user so as to be detectable in a low-resolution conversion image converted to have a resolution lower than the resolution of the specific comic contents, in a first embedded region specified by the embedded region specification information corresponding to the identification information of the specific comic contents, and
embeds, by means of the digital watermark, second user information including the first user information and additionally including history information of delivery of the specific comic contents as the user information of the identical specific user, so as to be detectable in a conversion image converted to have a resolution higher than the low-resolution conversion image and lower than the resolution of the specific comic contents, in a second embedded region different from the first embedded region in the identical page to or a different page from the first embedded region specified by the embedded region specification information corresponding to the identification information of the specific comic contents.

16. The copyright protection assistance system according to claim 8, wherein
the definition information of the embedded region of the embedded region specification information is defined based on a lateral base vector connecting corner end points in a lateral direction of a frame range in the page in the embedded region specification information and a vertical base vector connecting corner end points in a vertical direction of the frame range in the page.

17. The copyright protection assistance system according to claim 9, wherein
the definition information of the embedded region of the embedded region specification information is defined based on a lateral base vector connecting corner end points in a lateral direction of a frame range in the page in the embedded region specification information and a vertical base vector connecting corner end points in a vertical direction of the frame range in the page.

18. The copyright protection assistance system according to claim 10, wherein
the definition information of the embedded region of the embedded region specification information is defined based on a lateral base vector connecting corner end points in a lateral direction of a frame range in the page in the embedded region specification information and a vertical base vector connecting corner end points in a vertical direction of the frame range in the page.

19. The copyright protection assistance system according to claim 11, wherein
the definition information of the embedded region of the embedded region specification information is defined based on a lateral base vector connecting corner end points in a lateral direction of a frame range in the page in the embedded region specification information and a vertical base vector connecting corner end points in a vertical direction of the frame range in the page.

20. The copyright protection assistance system according to claim 12, wherein
the definition information of the embedded region of the embedded region specification information is defined based on a lateral base vector connecting corner end points in a lateral direction of a frame range in the page in the embedded region specification information and a vertical base vector connecting corner end points in a vertical direction of the frame range in the page.

21. The copyright protection assistance system according to claim 13, wherein
the definition information of the embedded region of the embedded region specification information is defined based on a lateral base vector connecting corner end points in a lateral direction of a frame range in the page in the embedded region specification information and a vertical base vector connecting corner end points in a vertical direction of the frame range in the page.

22. The copyright protection assistance system according to claim 14, wherein
the definition information of the embedded region of the embedded region specification information is defined based on a lateral base vector connecting corner end points in a lateral direction of a frame range in the page in the embedded region specification information and a vertical base vector connecting corner end points in a vertical direction of the frame range in the page.

23. The copyright protection assistance system according to claim 15, wherein
the definition information of the embedded region of the embedded region specification information is defined based on a lateral base vector connecting corner end points in a lateral direction of a frame range in the page in the embedded region specification information and a vertical base vector connecting corner end points in a vertical direction of the frame range in the page.

24. The copyright protection assistance system according to claim 8, wherein
the content delivery device receives, from the copyright management device, and stores the embedded region specification information uniformly set for the specific comic contents, having the identification information of the comic contents, the page of the comic contents, and the definition information of the embedded region in the page.

25. The copyright protection assistance system according to claim 12, wherein
the content delivery device receives, from the copyright management device, and stores the embedded region specification information uniformly set for the specific comic contents, having the identification information of the comic contents, the page of the comic contents, and the definition information of the embedded region in the page.

26. The copyright protection assistance system according to claim 16, wherein
the content delivery device receives, from the copyright management device, and stores the embedded region specification information uniformly set for the specific comic contents, having the identification information of the comic contents, the page of the comic contents, and the definition information of the embedded region in the page.

27. A copyright protection assistance system, wherein
a content delivery device is configured to store embedded region specification information having identification information of comic contents, a page of the comic contents, and definition information of an embedded region in the page, and user information of a logged-in user receiving delivery of the comic contents, embed, in response to a request for delivery of specific comic contents by a specific user, the user information of the specific user by means of a difficult-to-perceive digital watermark in the embedded region specified by the embedded region specification information corresponding to the identification information of the specific comic contents, and deliver the specific comic contents with the user information of the specific user embedded by means of the digital watermark, to a user terminal of the specific user,
a copyright management device
transmits, to the content delivery device, embedded region specification information uniformly set for specific comic contents, having identification information of comic contents, a page of the comic contents, and definition information of an embedded region in the page,
receives, from the content delivery device, and stores the identification information of the delivered specific comic contents and the corresponding user information of the specific user receiving delivery,
downloads, from a fraudulent server, fraudulent comic contents with contents at least partially identical to the specific comic contents having been illegally uploaded and disclosed,
detects the user information embedded by means of the digital watermark of the fraudulent comic contents in a region corresponding to the embedded region of the embedded region specification information of the specific comic contents, and
specifies the detected user information embedded by means of the digital watermark by collating the detected user information with the stored user information corresponding to the identification information of the specific comic contents.
